(19) United States
(12) Patent Application Publication
(10) Pub. No.: US 2008/0241339 A1
(43) Pub. Date: Oct. 2, 2008

(54) Hemp food product base and processes

(75) Inventors: Pat R. Mitchell, Stockton, CA (US); Khalid M. Shammet, Tracy, CA (US)

Correspondence Address: Robert Charles Hill, 235 Montgomery Street #821, San Francisco, CA, 94104, US

(73) Assignee: California Natural Products

(21) Appl. No.: 11/729,338

(22) Filed: Mar. 28, 2007

(51) Int. Cl. A23L 2/38; A23L 1/00

(52) U.S. Cl. 426/598; 426/507; 426/508

(57) ABSTRACT

A food process comprises starting with hemp (Cannabis sativa) seeds that have been cultivated to have low levels of tetrahydrocannabinol (THC) alkaloid, e.g., less than 0.3%. The hemp seeds are dehulled to produce split seed kernels, mixing the split seed kernels with hot water to hydrate them into a slurry, grinding the slurry to blend and smooth it into a product base, cooking the product base to achieve a particular flavor and aroma consistent with a target food product, cooling the product base to stop cooking, and further processing the product base into a target food product like soups and beverages. The products produced have high levels of protein, vitamins, and other nutritional values.

### FIELD OF THE PRESENT INVENTION

The present invention relates to food products and manufacturing processes for soups and beverages, and in particular to a nondairy food base from hemp.

### BACKGROUND

Cow's milk is a universally popular beverage because of its good taste, and its protein, calcium, vitamin, fat, and lactose nutritional values. Thirty years ago, various nondairy beverage substitutes for milk began to be marketed. The demand for these products came from consumers who could not digest or tolerate milk for some reason, but nevertheless wanted a drink that had similar nutritional and functional properties. Some of the problems with drinking milk were its need for refrigeration, short shelf life, dairy allergies (milk is a class-1 allergen), lactose intolerance, other negative health results, and philosophical reasons.

One of the first non-dairy substitute beverages that was a commercial success was soy milk. Soy milk is made by grinding and heating soy beans, removing the fibrous okara (soy pulp), clarifying, and pasteurizing into a soy base. Sweeteners, salt and flavors are normally added to the soy base to make a finished beverage. If the object is to mimic milk, then calcium, and vitamins A and D are added. Soy is naturally high in protein, so the nutritional profile is similar to milk by adding the sweetener, calcium and vitamins. But some of the disadvantages of soy milk include a strong “beany” flavor that is objectionable to many people, digestibility, soy allergies (soy is a class 1 allergen), low naturally occurring levels of calcium and vitamins A and D, it's not a whole grain beverage, it's low in fiber; and not very functional in cooking recipes.

Rice milk was another non-dairy beverage that became popular soon after soy milk did. Rice milk is made by cooking the rice, adding enzymes, and filtering to yield a rice base. The rice base is naturally sweet, so sweetener does not need to be added. Salt and flavors are usually added to the rice base to make a finished beverage that tastes good. When the object is to mimic milk, then calcium, oil, and vitamins A and D are added. Fortunately, rice is hypoallergenic. So the allergen issue that is prevalent with cow's milk and soy milk, is not an issue with rice milk. Rice is low in naturally occurring proteins, calcium, and vitamins A and D, it's not very functional in recipes, and it has a low fiber content.

According to the general definition, grain milk is a milk substitute made from hydrolyzed grain or from flour. Grain milk can be made from oats, spelt, rice, rye and einkorn wheat. Grain milk looks very similar to cow's milk. It has a lower protein content and a higher carbohydrate content than cow's milk. Just as cow's milk is often fortified with Vitamin D, which it naturally lacks, grain milks may have calcium and some vitamins added to them. Grain milk is low in saturated fat and contains no lactose, which is beneficial for those who are lactose intolerant. Grain milk also lacks casein, making it suitable for vegans and people with milk allergies. Flavored grain milk can come in plain, vanilla, chocolate or a variety of other flavors. Like unflavored grain milk, it is often available with added nutrients.

HighBeam Encyclopedia says Cannabis sativa hemp seed is grown extensively in the former Soviet Union as a food, and is consumed as an oatmeal. (http://www.encyclopedia.com/doc/1G1-113807045.html) Beverages made with boiled hemp seed have been described in medical literature as a soothing remedy for coughs and throat irritations. The seeds have been eaten in traditional treatments for constipation, diarrhea, and digestive problems. Hemp is rich in linoleic acid (omega-6), a type of essential fatty acid, a deficiency of which may cause infections, impaired wound healing, retarded growth, miscarriage, male sterility, skin eruptions, arthritic symptoms, behavioral disturbances, dehydration, liver or kidney degeneration, heart problems, poor blood circulation and hair loss. Hemp seed is the highest in essential fatty acid of any plant, up to 81% of total oil volume. Raw hemp seed oil is among the lowest in saturated fats, at 8% of total oil volume. Hemp seed is also a good source of gamma-linolenic acid (GLA), a particularly rare oil and a component in mother's milk.

Hemp itself is well known in the food industry. Like soybean, hemp seed extracts can be made into vegetable milk. The nutritional value of hemp seeds is very attractive, with about 35% protein, very high Omega-3 and Omega-6. Hemp seed is also rich in dietary fiber, carotene, vitamins B1, B2, B3, B6, C and E. About 35% of the seed is fatty acids. The seed also contains a complete protein. The protein in hemp is more digestible than soy protein due to edestin, a special type of protein.

Conventional processing includes crushing the seeds, de-fatting the seed from the oil, and using the powder that can be blended into milk, or other products to give them the nutritional value of the protein and the fiber. For example, powdered dry hemp seed can be mixed with sugar, cocoa powder and flavors for a dry mix that can be blended with water or milk by the consumer to make a drink.

### SUMMARY OF THE PRESENT INVENTION

Briefly, a food process embodiment of the present invention comprises starting with industrial hemp seeds with low levels of tetrahydrocannabinol (THC) alkaloid. The hemp seeds are dehulled to produce split seed kernels, mixing the split seed kernels with hot water to hydrate them into a slurry, grinding the slurry to blend and smooth it into a product base, cooking the product base to achieve a particular flavor and aroma consistent with a target food product, cooling the product base to stop cooking, and further processing the product base into a target food product like soups and beverages. The products produced have high levels of protein, vitamins, and other nutritional values.

An advantage of the present invention is a non-dairy beverage base is provided that is high in naturally occurring proteins, essential amino acids, zinc, magnesium, potassium, phosphorous, and iron.

Another advantage of the present invention is a beverage base is provided that is rich in essential fatty acids Omega 3 and 6, low in carbohydrates, pleasant flavor, milk-like appearance, hypoallergenic, and particular functionality in nutritional applications.

The above summary of the present invention is not intended to represent each disclosed embodiment, or every aspect, of the present invention. Other aspects and example embodiments are provided in the figures and the detailed description that follow.

### BRIEF DESCRIPTION OF THE DRAWINGS

The present invention may be more completely understood in consideration of the following detailed description of various embodiments of the present invention in connection with the accompanying drawings, in which:

FIG. 1 is a flowchart diagram of batch process embodiment of the present invention for making a hemp seed food product base; and

FIG. 2 is a flowchart diagram of continuous line process embodiment of the present invention for making a hemp seed food product base.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention as defined by the appended claims.

### DETAILED DESCRIPTION

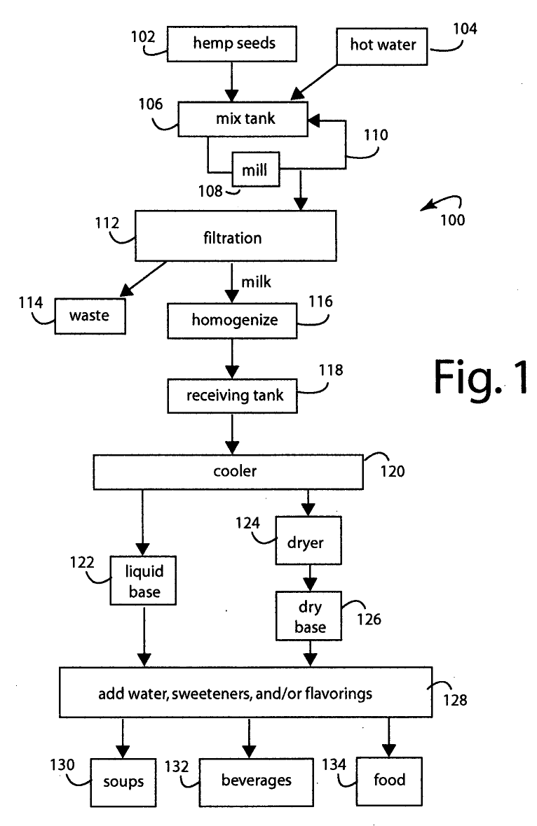

FIG. 1 represents a batch process embodiment of the present invention, and is referred to herein by the general reference numeral 100. Process 100 begins with hemp seeds 102 that have been cultivated to have low levels of tetrahydrocannabinol (THC) alkaloid, e.g., less than 0.3%. Hot water 104 heated to more than 200° F. is mixed with the hemp seeds in a mixing tank 106. Mixing ratios are in the range of 9-25% weight of hemp seeds to water, depending on the final applications. In general, five parts of water to one part hemp seeds is a good starting point.

The mixing tank 106 includes a steam-jacketed tank used to cook and thereby soften the mixture at 180-200° F., e.g., 10-30 minutes. Lower temperatures than that will not soften the hemp seeds well enough and yields will suffer. Cooking above 200° F. should be avoided because it tends to deteriorate the naturally occurring vitamins, minerals, and delicate Omega-3 and Omega-6 fatty acids.

The cooking of the hemp seeds in water causes them to swell as they absorb water and to soften. The expansion inside the shells caused by the swelling cracks open and helps to separate the shells from the nuts inside. A resulting slurry of hemp seeds and hot water is circulated through a wet mill 108 for loop grinding. A partially ground, milky mixture is returned in a recirculated slurry 110 to the mixing tank over-and-over for more softening and more grinding.

Such re-circulation is repeated until sample measurements reach target values, e.g., for product consistency and maximum yields. Such measurements include total solids percentage, pH, Brix, etc. Degrees BRIX (° Bx) is a measurement of a soluble dry substance in a liquid, and thus can be used to describe an approximate measure of sugar content. It is determined with a saccharimeter that measures the specific gravity of a liquid. For example, a 25° Bx solution has 25 grams of sucrose sugar per 100 grams of liquid.

The repeated milling usually takes about ten minutes, then a filtration step 112 follows. The shells, fibers, and other large solids are removed from the recirculated slurry 110 and disposed of in a waste 114. Mesh screens that get successively smaller and that are vibrated during operation help to yield a maximum of a base food product.

For example, a SWECO (Florence, Ky.) filter with a 60-100 mesh screen size as been used to maximize hemp yield while minimizing the hull fragments. Larger size screens can jeopardize product qualities like color, mouth-feel, and flavor in exchange for higher yields. Smaller screen sizes blind too easily and produce inefficient yields. The typical hemp slurry is pumped to the filtration system at 18-80 gallons-per-minute (gpm). An ideal target rate to maximize processing efficiency with typical equipment, like a 15,000 pound capacity, steam-jacketed mixing tank, has found to be about fifty-five gallons-per-minute.

A filtered hemp slurry with about 16% solids is then homogenized in a step 116 to stabilize it, and the resulting white creamy hemp milk is sent to a receiving tank 118. A cooler 120 lowers the temperature of a homogenized base product down to under 50° F., e.g., to stop oxidation of the delicate oils and vitamins. Otherwise, if kept too warm for too long, off-flavors and rancidity can quickly result.

A hemp base 122 is ready to be customized by adding water, emulsifiers, stabilizers, sweeteners, and/or flavorings in a step 124 to produce finished hemp protein products like soups 126 or beverages 128. Dry or liquid hemp base 122 can also be sold as-is for other food manufacturers to make their own finished products. One way to produce a dry base product is to spray out the liquid base to evaporate the water, a yellowish base powder residue results that comprises only the proteins and fats.

Aseptic processing will extend the product shelf life, e.g., to as much as a year. Aseptic processing involves sterilizing the product using an ultra-high temperature (UHT) process that rapidly heats, and then cools the product before filling. The processing equipment allows the time (3-15 seconds) and temperature (195° F.-285° F.) to be tailored to place the least amount of thermal stress on the product while ensuring consumer safety. The sterile product is then sealed in sterile packaging. In embodiments of the present invention, the liquid hemp base 122 will be chalk white and have a good flavor.

In one embodiment of the present invention, a 2,000 gallon steam jacketed tank is filled with 3,000 pounds of dehulled hemp seeds. About 12,000 pounds of water heated to 200° F. is added to make a hemp slurry that is then cooked for fifteen minutes. The cooking temperature is kept within 190° F. to 200° F. Extreme high temperatures outside this range can deteriorate the naturally occurring vitamins and minerals, and increase the oxidation of the delicate omega-3 and omega-6 essential fatty acids (EFA's). The cooking softens the hemp seeds for milling through a wet mill, e.g., a BOSTON SHEAR PUMP. After cooking, the hemp slurry is recirculated through the wet mill over and over for fifteen minutes. The wet mill grinds the slurry into a uniform concentrate and prepares it for filtration. The milled hemp slurry is filtered through 80-mesh (178-micron) screens, e.g., using two SWECO filters, at fifty gallons per minute (50 GPM). The filters remove foreign materials and any remaining seed hulls. The filtered hemp slurry is homogenized to produce a stable, maintainable product. It is then cooled and stored at 50° F. until further processing, e.g., by the end-user or a specialty manufacturer. The creamy, white hemp “milk” is ideal for use in non-dairy beverages.

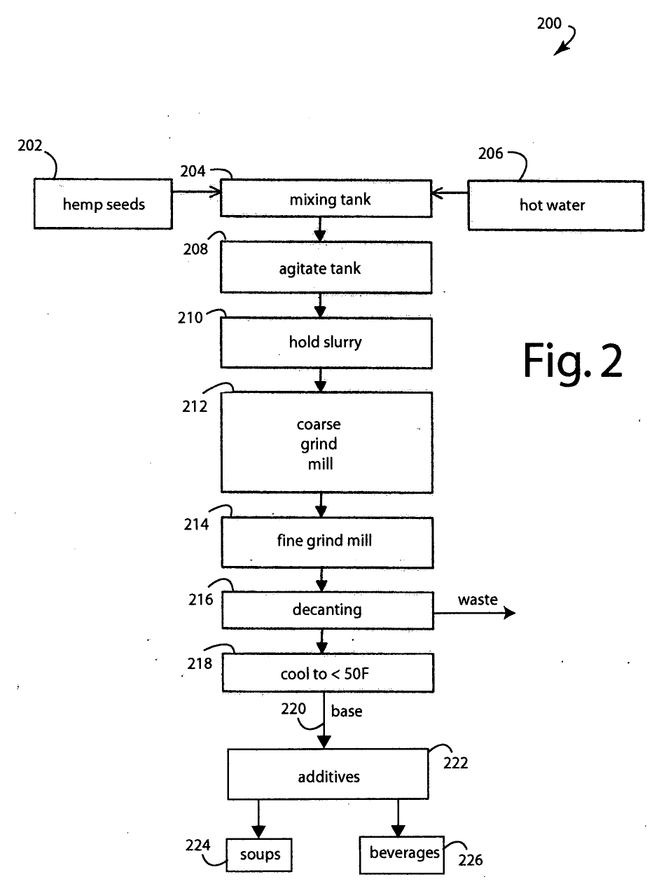

Referring to FIG. 2, in a continuous line process embodiment of the present invention, referred to herein by the general reference numeral 200, semi-dehulled cannabis sativa seeds 202, with THC less than 0.3%, are dispensed into a feed mix tank 204 at fifty pounds per minute with two hundred and eight pounds per minute of a hot water flow 206 at a temperature of 180° F. E.g., in a ratio of about 50:208, hemp seeds to hot water. The feed mix tank is agitated 208 and the slurry is held 210 for at least thirty seconds before being released to a first grinding mill 212. For example, a perforated disc mill, such as made by FRYMA, can be operated at 3600 RPM to pulverize and macerate the seed kernels in the coarse slurry into particles less than two millimeters in diameter. A second mill 214, e.g., a FRYMA colloid mill, operating at 3600 RPM shears and grinds the hemp seed particles. The strong stirring force 216 from the second mill makes a well dispensed, blended slurry that is decanted. A decanter centrifuge 216 is used to separate the solids from the liquids in the slurry. The solid (waste) material has a high amount of protein, and the liquid decanting product is high in fat content.

Alternatively, a chiller 218 is used to cool a base 220. Sweeteners, flavorings, minerals, vitamins, and other additives 222 can be mixed into the base 220 to produce soups 224 and beverages 226.

While the present invention has been described with reference to several particular example embodiments, those skilled in the art will recognize that many changes may be made thereto without departing from the spirit and scope of the present invention, which is set forth in the following claims.

1. A food making process, comprising:
cooking hemp seeds in water to hydrate and soften them for shell removal and grinding;
wet milling a resulting slurry in a loop to remove fibrous material from the hemp seeds;
filtering out solids from said slurry;
homogenizing a liquid base filtered from the slurry;
cooling said liquid base to stop oxidation;
wherein said liquid base is used in further processing to product a food or beverage.

2. The food making process of claim 1, wherein:
the step of cooking uses temperatures in the range of 180° F. to 200° F.

3. The food making process of claim 1, wherein:
the step of wet milling proceeds after a minimum of ten minutes of cooking.

4. The food making process of claim 1, wherein:
the step of filtering proceeds after measurements confirm target characteristics have been reached in order to produce a consistent product quality.

5. The food making process of claim 1, further comprising:
aseptic processing to extend the shelf life of said liquid base.

6. A process for making foods and beverages from hemp seeds, comprising:
add hemp seeds to water in a particular ratio and to soften the hemp seeds for milling;
recycling a slurry of the hemp seeds and water through a wet milling machine;
filtering the slurry to remove solids with mesh screens that get successively smaller and that are vibrated during operation to yield a base food product.

7. The food making process of claim 6, further comprising:
mixing said base food product with ingredients to produce a final food or beverage for consumption.

8. The food making process of claim 7, further comprising:
aseptic processing before sterile packaging to extend product shelf life.

9. A product of a batch process comprising:
filling a steam jacketed tank with about one pound of dehulled hemp seeds to about four pounds of water heated to 200° F. to make a hemp slurry;
cooking said hemp slurry for about fifteen minutes, wherein the cooking temperature is kept to within 190° F. to 200° F., and the cooking softens the hemp seeds for milling;
milling said hemp slurry after cooking through a wet mill that grinds the slurry into a uniform concentrate and prepares it for filtration;
filtering a milled hemp slurry to remove foreign materials and any remaining seed hulls; and
homogenizing a filtered hemp slurry to produce a stable, maintainable product, that is then cooled and stored at 50° F. until further processing;
wherein a creamy, white hemp “milk” is produced for use in non-dairy beverages.

10. A product of a continuous process comprising:
dispensing one pound per minute of semi-dehulled cannabis sativa seeds with THC less than 0.3% to about four pounds per minute of a hot water flow at a temperature of 180° F. into a feed mix tank;
agitating said feed mix tank and holding a resulting hemp slurry for at least thirty seconds before being releasing to a first grinding mill pulverizing and macerating seeds in a coarse slurry using a first mill to yield solid particles less than two millimeters in diameter;
grinding the hemp seed particles in a second mill with a strong stirring force to make a well dispensed, blended slurry; and
decanting in decanter centrifuge to separate the solids from the liquids in said blended slurry;
wherein a solid waste material is high in protein, and a liquid decanting product is high in fat content.
